(19) United States
(12) Patent Application Publication
(10) Pub. No.: US 2013/0174747 A1
(43) Pub. Date: Jul. 11, 2013

(54) COOKING APPLIANCE

(71) Applicants: Pui Chi Ching, Hong Kong (HK); Ding Zheng Zhou, Hong Kong (HK); Wing Chung Lau, Hong Kong (HK); Wai Hing Lai, Hong Kong (HK)

(72) Inventors: Pui Chi Ching, Hong Kong (HK); Ding Zheng Zhou, Hong Kong (HK); Wing Chung Lau, Hong Kong (HK); Wai Hing Lai, Hong Kong (HK)

(73) Assignee: Pui Chi Ching, Hong Kong (CN)

(21) Appl. No.: 13/812,354

(22) PCT Filed: Sep. 27, 2010
(86) PCT No.: PCT/CN2010/077369

§ 371 Date: Jan. 25, 2013

(51) Int. Cl. A47J 37/12

(52) U.S. Cl. CPC A47J 37/1266
USPC 99/407

(57) ABSTRACT

A cooking appliance (2,20) comprises a first container (8, 26), a base (6, 44), an axle (10, 42) extending generally vertically from a bottom of the first container (8, 26), and a second container (12, 32) including a vertically extending funnel (34) which is engageable with a male member (46) arranged at an upper end of the axle (10, 42). The cooking appliance (2, 20) can assume a configuration in which the second container (12, 32) is rotatably drivenable by the male member (46) in relation to the first container (8, 26), to remove liquid from food contained in the second container (12, 32).

### CROSS-REFERENCE TO RELATED APPLICATIONS

This application is a National Stage of International Application No PCT/CN2010/077369, filed on Sep. 27, 2010, which is herein incorporated by reference in its entirety.

### FIELD OF THE INVENTION

The present invention is concerned with a cooking appliance which can, among other functions, remove excess liquid from food.

### BACKGROUND OF THE INVENTION

There are a vast variety of cooking appliances tailored to perform respective specific functions in preparing or cooking food. For example, electric food fryers have been around for a long time for frying food conveniently. After frying, food removed from the fryers is usually collected in a basket, allowing oil contained in the food be dripped out of the basket. This process is adopted in many kitchens including kitchens in fast food stores. For instance, fried fries are allowed to sit in a basket for cooling and excess oil be dripped out of the basket. Despite the good intention of removing excess oil, the passive procedure of allowing the food to sit in the basket is often not satisfactory.

The present invention seeks to address this problem effectively and/or efficiently, or at least to provide a useful alternative to the public.

### SUMMARY OF THE INVENTION

According to a first aspect of the present invention, there is provided a cooking appliance configured to provide a first function of removing liquid from food, comprising (a) a first container, (b) a base, (c) an axle extending generally vertically from a bottom of the first container, (d) a second container including a generally vertically extending funnel and engageable with at an upper end (e.g. in the form of a male member) of the axle, wherein the cooking appliance is configured to assume a first configuration in which the second container is rotatably drivenable in relation to the first container for removing liquid from food contained in the second container, or a second configuration in which the second container is not rotatably drivenable, wherein the upper end of the axle includes a spring member formed into a structure with at least two fingers, and wherein the spring member is biased to assume an expanded configuration which allows the spring member to expand against an upper interior wall of the funnel and the second container to maintain position in the first configuration.

The cooking appliance may be relatively compact in size and may suitably be used in a domestic dwelling; the first container may have an oil capacity in the range from 0.5 L to 5.0 L.

The cooking appliance may comprise a motor arranged at a lower end in the base. The location of the motor at the lower end can lower the center of gravity of the cooking appliance and enhance the stability of the cooking appliance in operation. In one embodiment, the cooking appliance may be configured to rotate the second container to a speed from 100 rpm to 1000 rpm.

Suitably, the second container may be sized and shaped to contain food with a weight ranging from 100 g to 3 kg. In one embodiment, the second container may be formed in a sieve-like structure for facilitating transfer of liquid from food contained therein to the first container.

In one embodiment, the funnel may be provided with a lower end having a tapered opening for receiving and aligning with the male member. Proper alignment with the male member minimizes jamming from happening. The funnel may be provided with an indentation against which the male member or the fingers engage in the first configuration.

In another embodiment, the at least two fingers may be arranged side by side, of equal dimension and generally define a plane along which, in use, the spring member, expands in the first configuration, or compresses in the second configuration. At least one of the fingers may have an elongate profile.

The spring member may be provided with opposite outwardly facing convex surfaces for engagement with the upper interior wall of the funnel. The convex surfaces facilitate easy fitting of the second container to the axle, removal of the second container from the axle, or lowering or lifting of the second container in the first container along the axle.

In a preferred embodiment, the spring member may be in the form of a leaf spring bent into shape from a strip of elongate metallic material with a thickness ranging from 0.2 mm to 1 mm and a width from 3 mm to 9 mm. Alternatively, the spring may be a round spring as well.

The male member may be provided with two tongues sandwiching the fingers but without interfering with biasing movement of the fingers. The tongues are relatively rigid and serve to, among other functions, enhance the structural integrity of the male member and functioning of the fingers.

The male member may alternatively include three fingers or at least three fingers of generally equal dimension, and/or arranged on a plane defined and shared by the three fingers.

Preferably, the cooking appliance may comprise a cover for closing the first container and a coupler attached to an underside of the cover; the coupler may be positioned, sized and shaped to restrict lateral movement of the axle or the male member.

The above cooking appliance may be a combination fryer and food spinner configured to provide a second function of frying food. In other words, the combination cooking appliance may be used to fry food and to remove excess oil from the fried food.

The cooking appliance may comprise a stabilizer arranged at a lower end in the base and with one or more stabilizers with a total weight up to 8 kg. The overall weight of the appliance may be less than 10 kg.

According to a second aspect of the present invention, there is provided a combination food fryer and food spinner, comprising (a) a first container, (b) a second container receivable in the first container, the second container including a vertically extending funnel snap-fittable with a male member of an axle extended from a bottom of the first container, wherein the cooking appliance is configured to assume a first configuration in which the second container is rotably drivenable in relation to the first container for removing liquid from food contained in the second container or a second configuration in which the second container is positioned in a lower end in the first container in which food is fried, and wherein the male member includes at least two fingers formed from at least one leaf spring and is biased towards a laterally expanded arrangement against an upper interior wall of said funnel, such that in the first configuration the second container is removably connected with said male member, allowing the cooking appliance to maintain position.

According to a third aspect of the present invention, there is provided a coupling system for use in a kitchen appliance, comprising an axle including a male member at one end thereof, a spinable funnel member engageable with the male member, wherein the system is configured to assume a first configuration in which the funnel member is rotatably drivenable by the male member or a second configuration in which the funnel member is not rotatably drivenable by the male member; and wherein the male member includes at least two fingers formed from at least one leaf spring and is biased towards a laterally expanded arrangement against an upper interior wall of the funnel member such that the container is removably connected with the male member, allowing the funnel member to maintain position in the first configuration for spinning purpose.

### BRIEF DESCRIPTION OF DRAWINGS

Some embodiments of the present invention will now be described by way of example and with reference to the accompanying drawings, in which:

FIG. 1 is a simplified cross section view showing a first embodiment of a cooking appliance in accordance with the present invention;

FIG. 2 is a schematic cross section view showing a second embodiment of a cooking appliance in accordance with the present invention;

FIG. 3c is a top view of part of the cooking appliance in FIG. 2;

FIG. 3a is a cross section view taken at line B-B of FIG. 3c;

FIG. 3b is a cross section view taken at line C-C of FIG. 3a;

FIGS. 4, 5, 7 and 8 show perspective views of different configurations of coupling mechanism of the cooking appliance shown in FIG. 2;

FIG. 6 corresponds to FIG. 5 and is a schematic perspective cut-open view showing an interior of the coupling mechanism in FIGS. 4, 5, 7 and 8;

FIG. 9a is a cross section view showing an embodiment of a male member which may be used in the coupling mechanism of FIG. 4 or the cooking appliance of FIG. 2 in accordance with the present invention;

FIG. 9b is a cross section view taken at D-D of FIG. 9a;

FIG. 10a is a cross section view showing a different embodiment of a male member which may be used in the coupling mechanism of FIG. 4 or the cooking appliance of FIG. 2 in accordance with the present invention; and

FIG. 10b is a cross section view taken at E-E of FIG. 10a.

### DETAILED DESCRIPTION OF PREFERRED EMBODIMENTS OF THE PRESENT INVENTION

The present invention is concerned with a cooking appliance which can remove excess liquid (e.g. oil) from food. The present invention is applicable in providing a combination appliance of a fryer for frying food and a spinner for removing excess oil from the food after frying. Such combination appliance is particularly useful for users who enjoy eating fried food but do not wish to consume excessive oil from fried food for health reason.

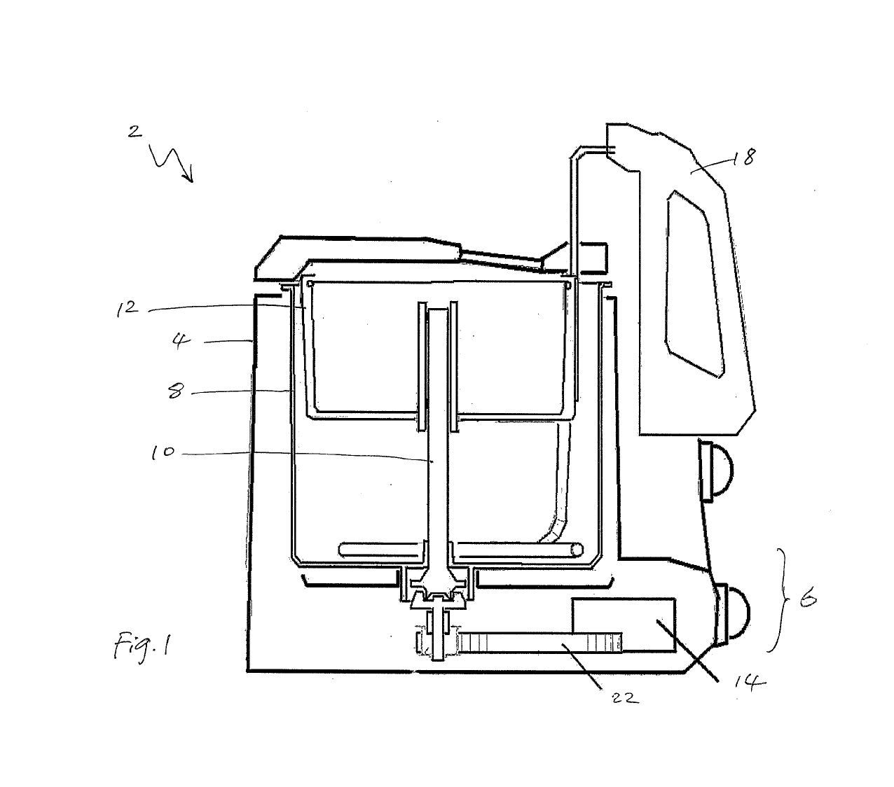

FIG. 1 shows the general profile of a first embodiment of a combination appliance of food fryer and food spinner and is generally designated 2. The appliance 2 comprises a housing 4, a base 6, a first (oil) container 8 received in the housing 4, an axle 10 extending from a bottom of the oil container 8 and a second (food) container 12. The base 6 includes a motor 14 for driving the axle 10 via a belt 22, which in turn rotates the food container 12 for spinning. The food container 12 is in the form of a basket which in a first configuration fits around and secures at an upper end of the axle 10. The food container 12 is attached to a handle 18 arranged exterior to the housing 4 via relatively rigid wire loops.

In use, when a user is ready to fry food contained in the second container 12, the cooking appliance 2 adopts a second configuration (not shown in FIG. 1) in which the second container 12 is lowered into the first container 8 such that the food in the second container 12 is immersed in oil for frying. After a food frying exercise has completed, the basket 16 is secured at the upper end of the axle 10 away from the oil as shown in FIG. 1. In this configuration, the second container 12 is caused to spin, thus removing excess oil from the food.

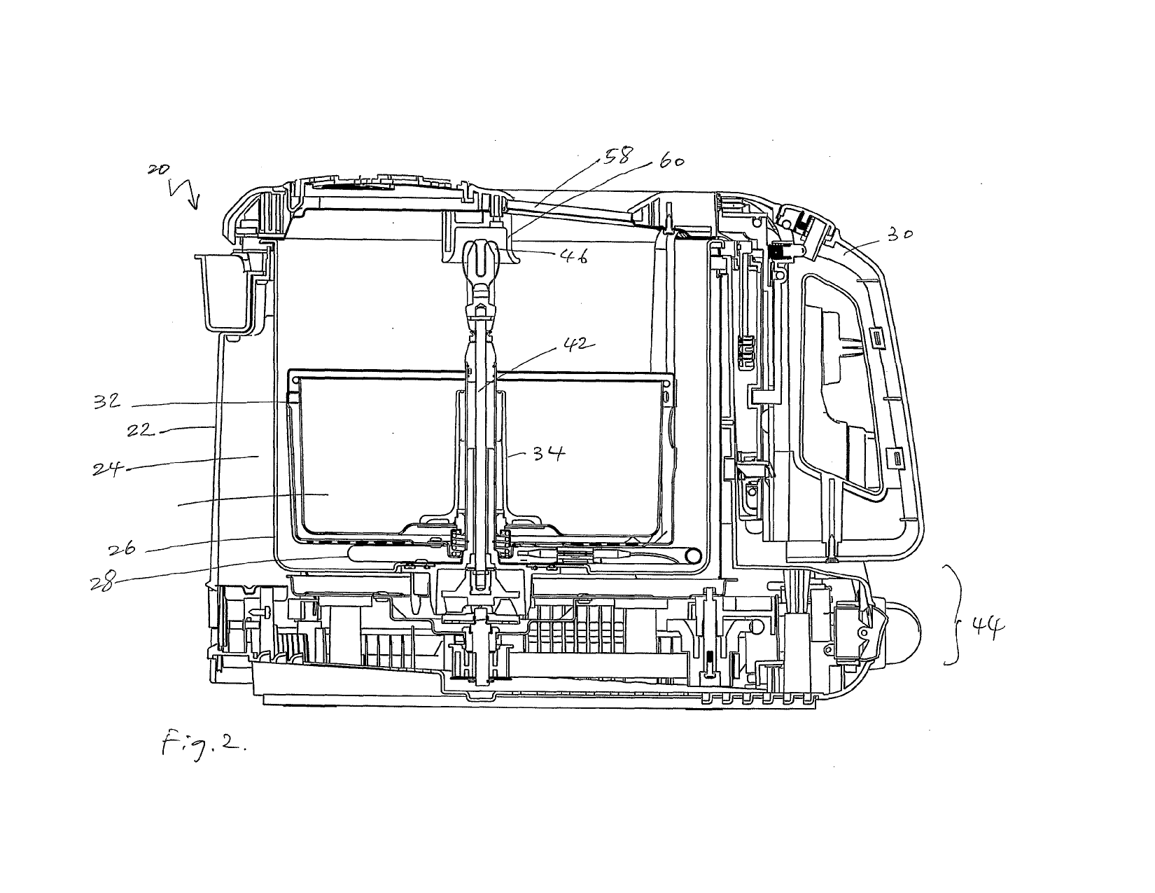

A number of issues however are to be addressed. The appliance 2 should preferably be designed such that when food frying is desired the food container 12 or the basket can be reasonably easy to fit around the axle 10 and lowered into or removed from the bottom of the oil container 8. This can be done by designing the food container 12 with a relatively large through-hole in the center thereof and the axle 10 with a relatively small diameter such that the axle 10 can freely enter or exit the through-hole with little difficulty. However, such design alone may be insufficient because with the substantially larger through-hole the food container 12 will be difficult to maintain in a higher position at which the axle 10 can engage or rotate the food container 12 for spinning excess oil away from the food contained therein. As such, the through-hole should not be too large and should be sized and shaped to be slightly larger than the axle 10 such that while the food container 12 can slide up and down along the axle 10 with little difficulty, the axle 10 can also engage with the food container 12 sufficiently securely for rotation purpose. FIG. 2 illustrates a second embodiment of a cooking appliance 20 in accordance with the present invention provided with a coupling mechanism which can more effectively achieve such functions.

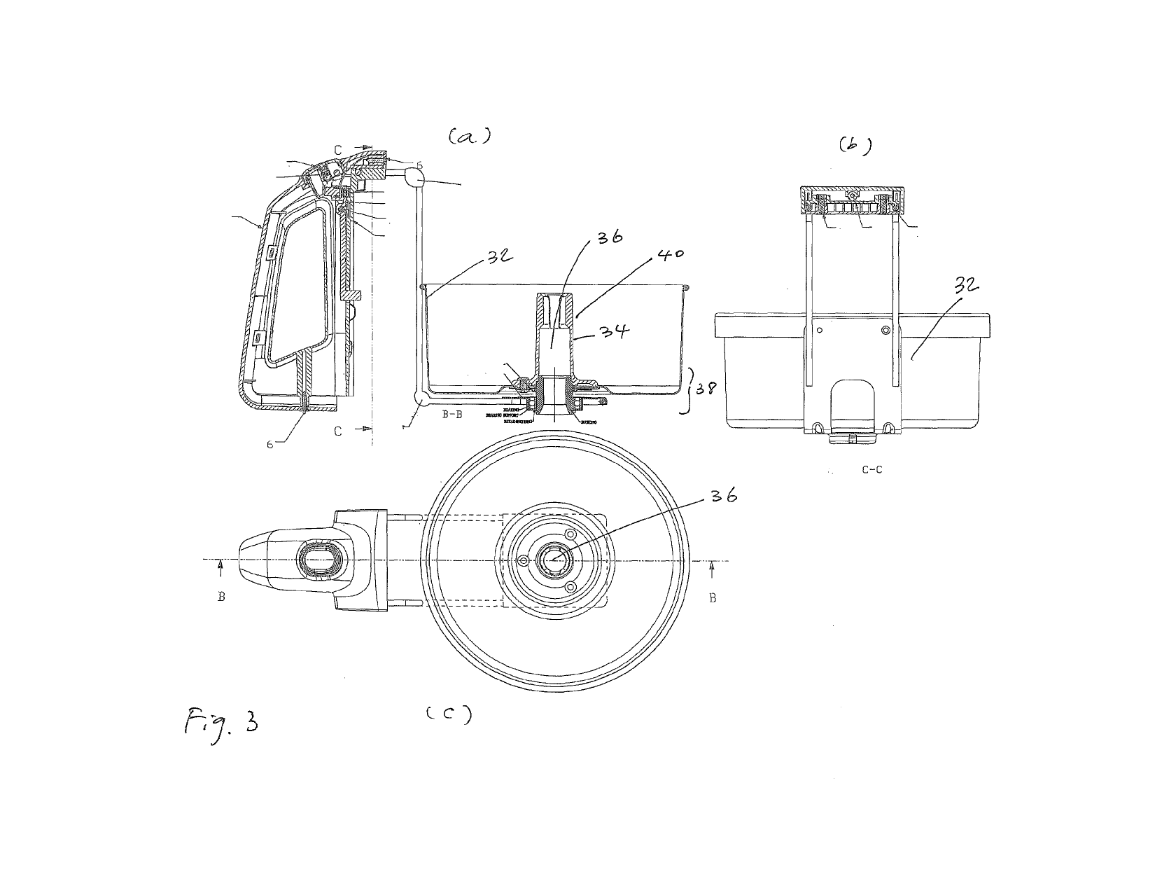

FIG. 2 is similar to FIG. 1 although it contains more details of the embodiment. The cooking appliance 20 similarly is provided with a housing 22 defining a cavity 24 in which a first container 26 for oil is received therein. In this particular embodiment, the oil container 26 has a capacity of 4 L although in alternative embodiments, the oil capacity may vary or in the range from 0.5 L to 5.0 L. Loops 28 of heating element are arranged at a bottom of the oil container 26 for providing heating power to the oil for food frying. A handle 30 external to the housing 22 is provided and is connected to a second container 32 for containing food to be fried, as shown also in FIGS. 3a to c.

The food container 32 takes the form of a sieve made principally of wire mesh. In this embodiment, the food container 32 is configured to hold food with a weight ranging from 100 g to 3 kg.

The food container 32 is provided with a funnel 34 at its center with a generally vertically disposed circumferential wall defining a through-hole 36. A lower end 38 of the funnel 34 is slightly larger than an upper end 40 thereof and is tapered, as clearly shown in FIG. 3a. The funnel 34 is provided with a pair of channels on opposite side in a mid-section of the wall. The upper end 40 of the circumferential wall is provided with an area of indentation.

An axle 42 vertically extends from a bottom of the oil container 26. The axle 42 is rotatably driven by a motor arranged in a base 44 of the cooking appliance 20. The axle 42 is provided with a rotatable male member 46 at an upper end thereof for engagement with the upper end 40 of the funnel. The motor is configured to be able to drive rotation of the male member 46 and thus the food container 32 to rotate at a rate from 100 rpm to 1000 rpm.

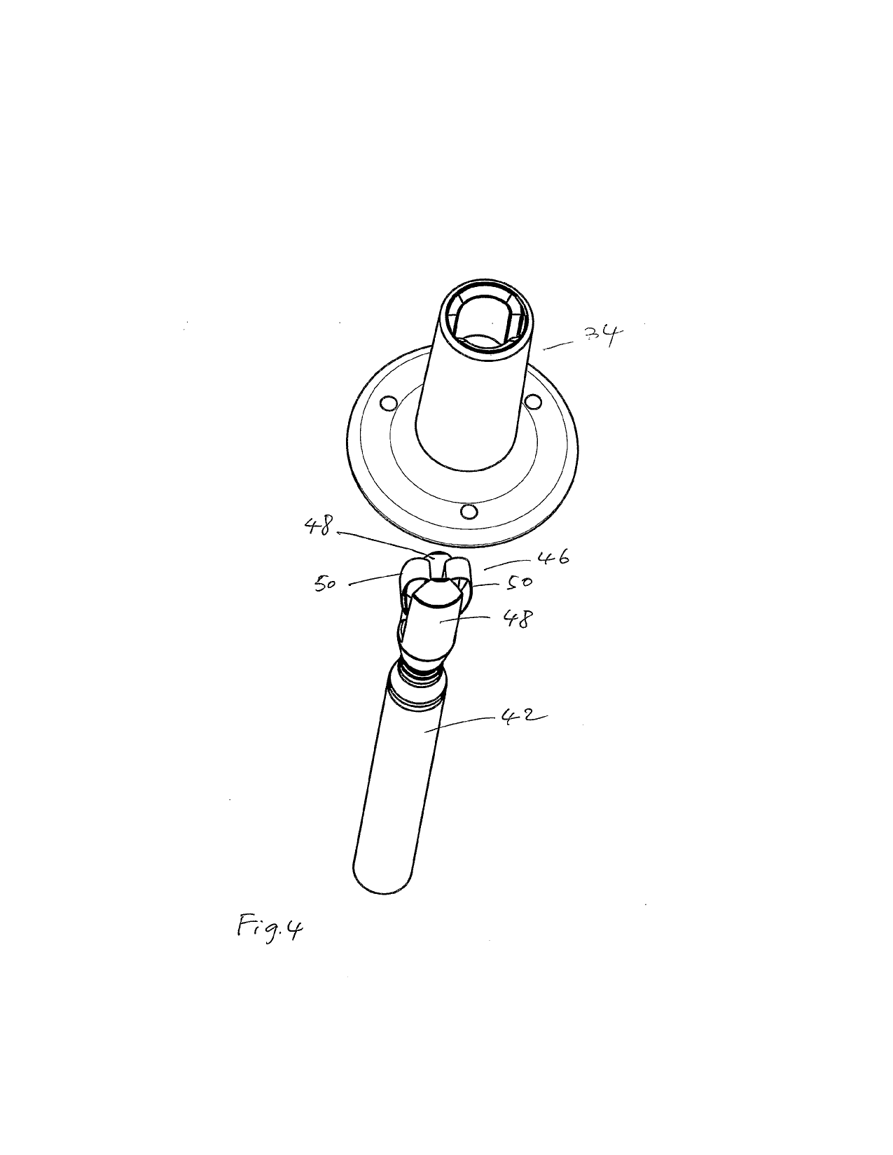

For clarity purpose, FIG. 4 illustrates just the axle 42 with the male member 46 and the funnel portion 34 of the second container 32. In this figure, it is shown that the funnel portion 34 is situated with the through-hole above the male member 46. Due to larger size of the lower end of the through-hole, the male member 46 can enter the through-hole relatively easily.

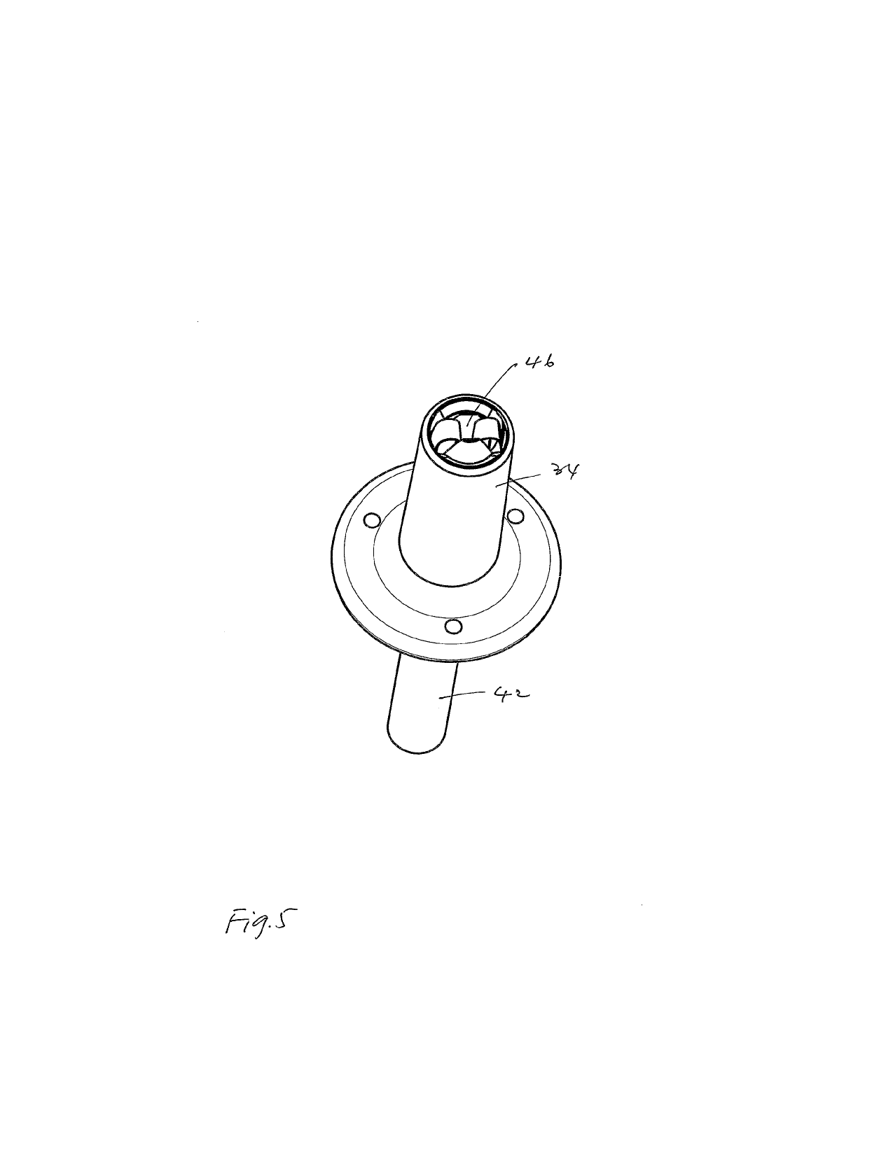

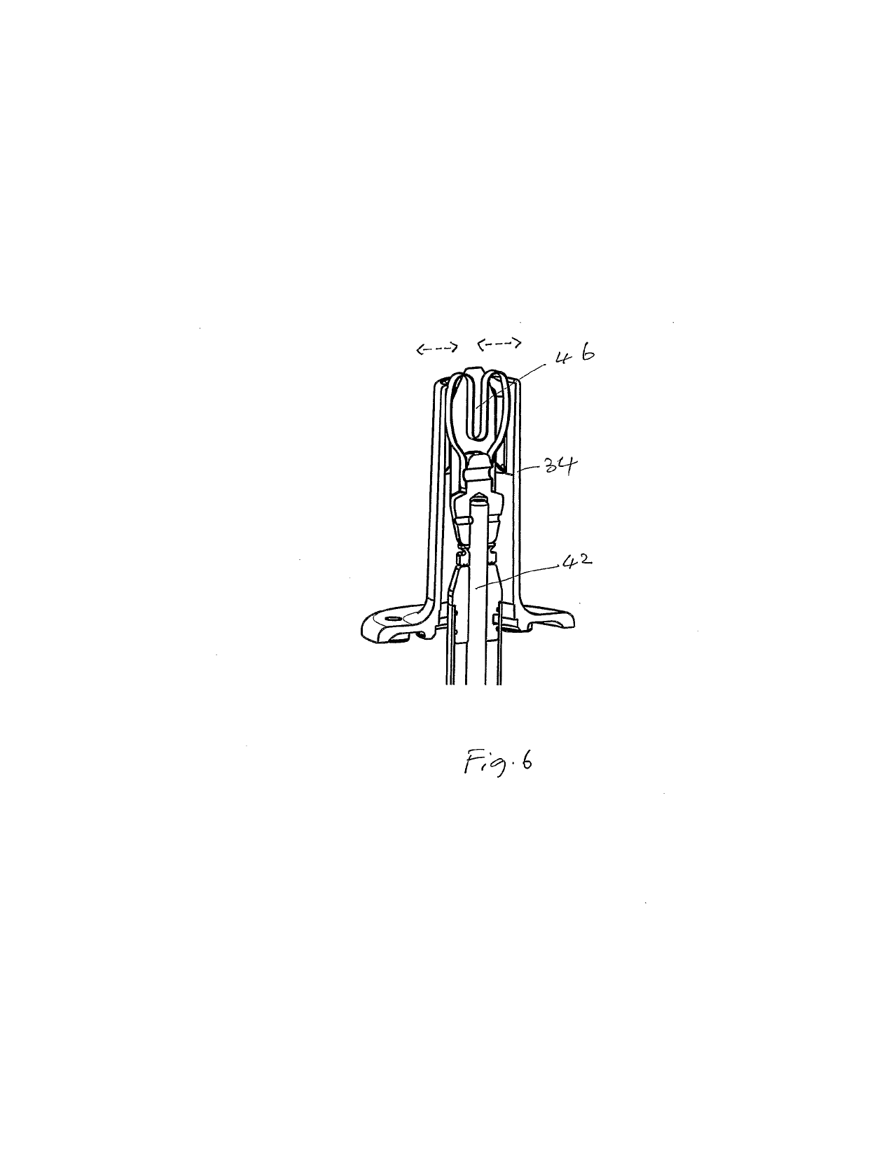

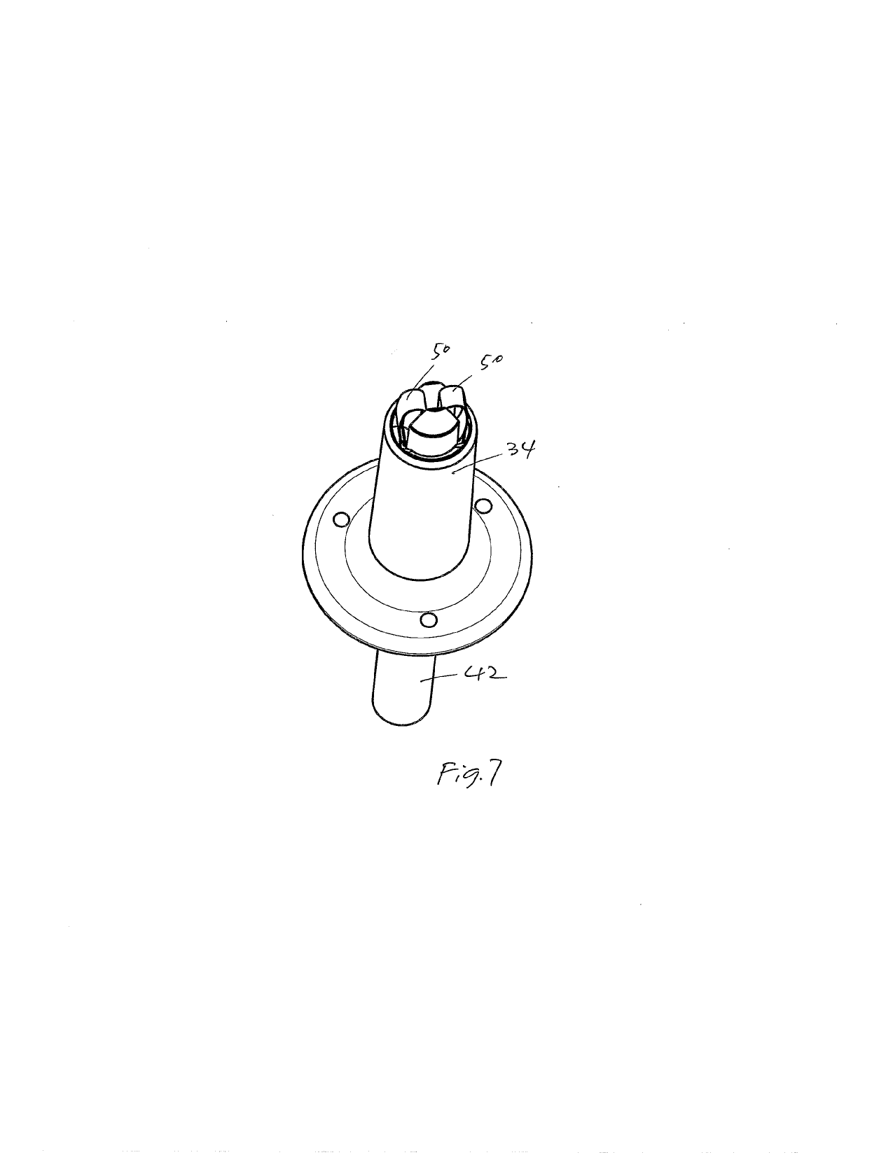

FIG. 5 illustrates that the axle 42 has entered the through-hole to the extent that the male member 46 has reached the upper end of the funnel 34. The male member 46 has a slightly larger head which engages with the indentation of the funnel 34. FIG. 6 illustrates an interaction of the male member 46 and the upper end of the funnel 34.

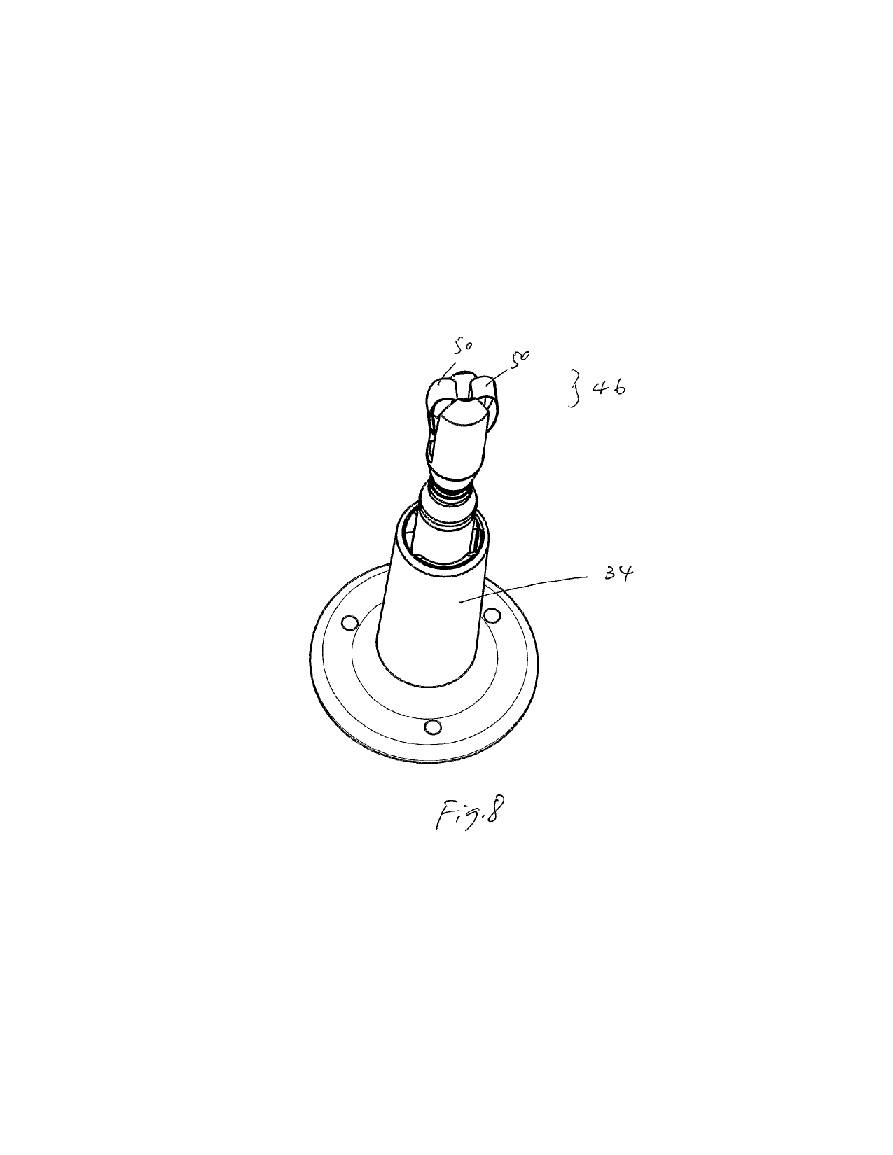

As the axle 42 continues to enter the through-hole 36, the male member 46 passes through the through-hole, as shown in FIG. 8. FIG. 8 illustrates the arrangement of the axle 42 in relation to the funnel 34 when the cooking appliance 20 is in its second configuration.

As can be seen in the figures (e.g. FIG. 4), the male member 46 is provided with a pair of tongues 48 sandwiching a pair of fingers 50. The tongues 48 serve to strengthen the structural integrity of the male member 46, restrict movement of the fingers 50 to a lateral path and facilitate insertion of the axle 42 to the funnel 34. The tongues 48 however do not interfere with biasing movement of the fingers 50.

In this embodiment, a stabilizing weight member is provided in the base 44 at the lower end of the appliance 20 so that the appliance 20 can remain stable on a kitchen countertop even when food spinning is taking place. The weight member is about 2.5 kg in this embodiment. The total weight of the appliance, in the embodiment, is less than 5 kg.

The following describes the male member 46 and how it operates in a more detailed fashion.

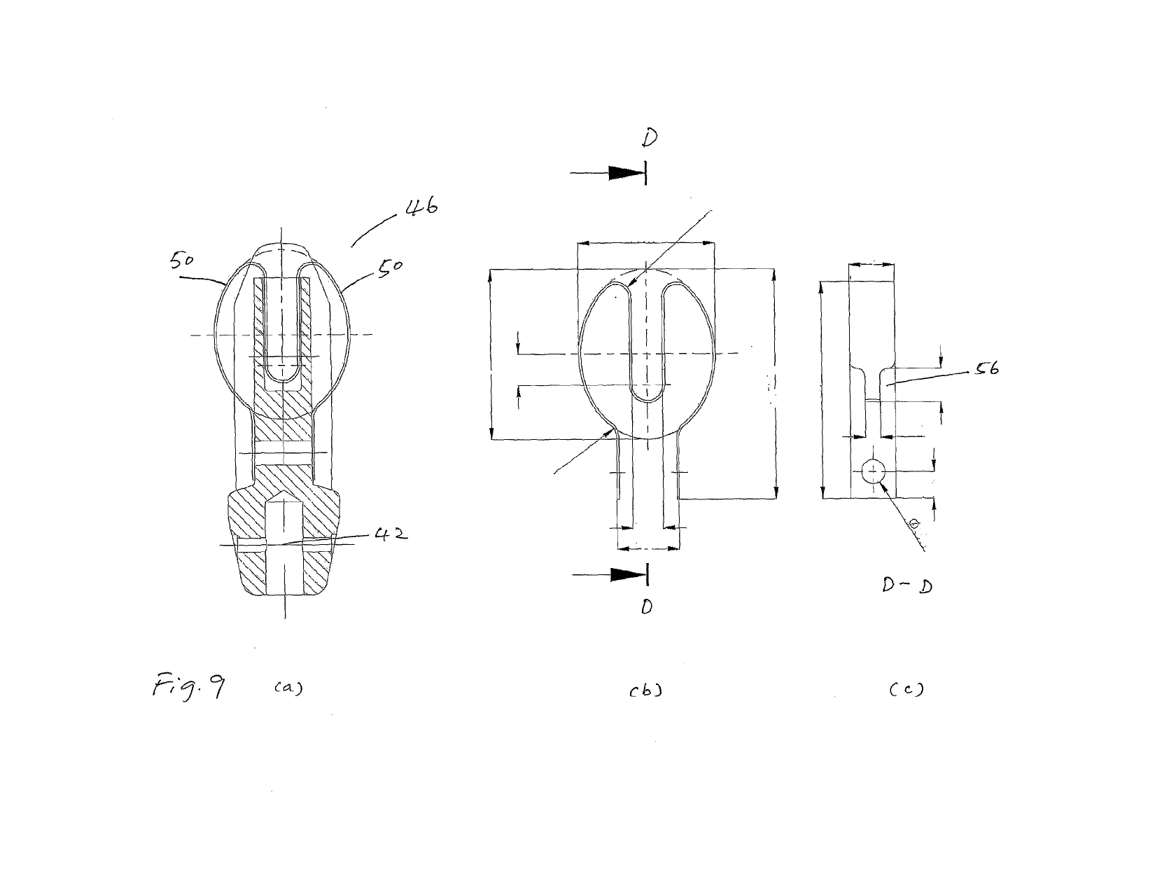

FIG. 6 and FIG. 9a illustrate the coupling mechanism and the male member 46 by way of a cut-open view and cross section views. The male member 46 includes a thin metallic strip 52 made from a resilient leaf spring type material (e.g. stainless steel, brass, etc.) bent to form into a loop shape. The loop shape resembles two upwardly extending elongate fingers 50. In this embodiment, the thickness of the strip is about 0.5 mm although studies have shown that in other embodiments the thickness of 0.2 mm to 1 mm will work satisfactorily. FIG. 9b illustrates just the thin metallic strip of the male member 46. The two fingers 50 are spaced apart by a small distance allowing them to move slightly and flex sideways but are otherwise symmetric. It is the movement and flexing of the fingers 50 which allows the engagement or disengagement with the male member 46. In this embodiment, the loop is configured such that opposite outwardly facing concave surfaces 54 are provided. These surfaces 54 are the area which first enters and faces the tapered end of the funnel 34, and are then guided to move along the channels and finally reach and engage the indentation of the funnel 34. The shape and dimension of the male member 46 and the funnel, and the resiliency of the fingers 50, together, are designed such that the food container 32 can be secured with and rotated by the male member 46 of the axle 42. When the food container 32 is secured against the male member 46, rotation of the food container effects removal of excess oil from the food. Oil removed from the food is transferred from the food container 32 back to the oil container 26.

Due to the resiliency of the fingers 50, they have a natural tendency to assume an outwardly biased configuration. It is to be understood that when the upper (or narrower) end of the funnel 34 is fitted around the fingers 50, the fingers 50 are slightly compressed towards each other and the biasing action of the male member allows the fingers to expand and releasably engage with the indentation of the funnel, thus holding the food container in position for rotation (see FIG. 6). When the food container 26 is lowered with an external force by a user, the upper end of the funnel 34 passes the male member 46, the fingers 50 become out of engagement with the funnel 34, and the food container 32 is then lowered to the bottom of the oil container 26 when food frying can take place. On the other hand, when the food container 26 is instead lifted such that the upper end therefore has passed the male member 46, the food container 26 can be removed from the appliance 20.

In this particular embodiment, the metallic strip has a narrower neck region 56 (see FIG. 9c) although this is not essential. As long as the fingers 50 can provide a biasing force large enough to hold the food container 32 in place for food spinning, the coupling mechanism will be satisfactory.

Referring to FIG. 2, the cooking appliance 20 is provided with a lid 58 for closing the appliance 20. A coupler 60 in the form of an inverted cup is fixedly secured to the underside of the lid 58. The coupler 60 is dimensioned and positioned such that when the lid 58 is closed the male member 46 or the upper end of the axle 42 is partly inserted into the coupler 60. It is to be understood that during rotation of the axle 42 and spinning of the food container 32, there may be a certain degree of imbalance (especially when position of food in the food container is not evenly distributed). The function of the coupler 60 restricts lateral movement or excessive vibration of the axle 42 and minimizes damages to the axle 42 or the motor when food spinning takes place.

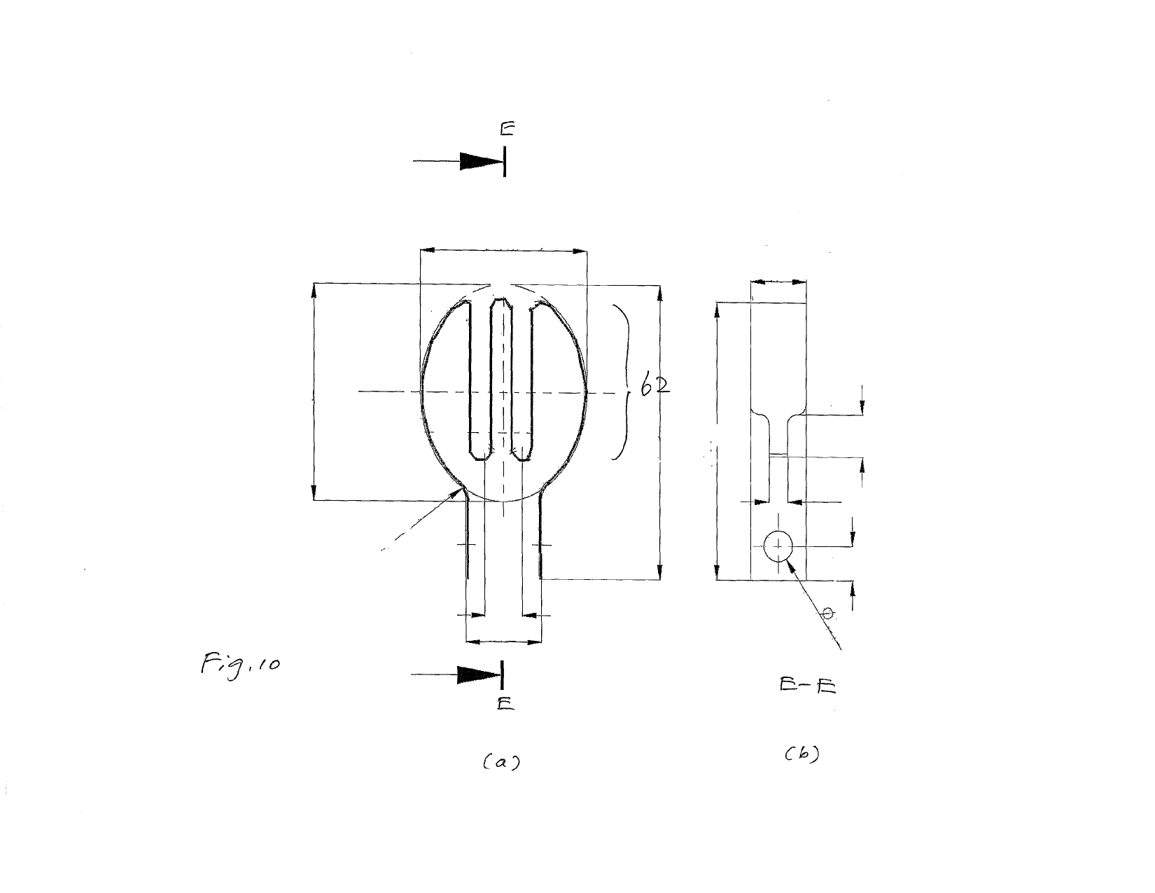

FIG. 10a illustrates an alternative embodiment of a coupling mechanism in which a male member 62 (similar to the male member 46) is provided with a three-finger or three-prong head. FIG. 10b is a cross section view taken at line E-E. The three fingers align on and share a same plane along which lateral movement thereof takes place. Such embodiment can work equally well.

While the above cooking appliances take the form of a combination food fryer and food spinner, it is envisaged that in another embodiment the cooking appliance may take the form of a salad spinner. Yet in another embodiment, the cooking appliance may take the form of a combination pasta boiler and pasta spinner.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. Further, minor modifications without departing from the ambit of the invention will be readily realized by a skilled person on reading this description. For example, the strip of the male member 46 may be made of a spring wire forming the fingers 50.

1. A cooking appliance configured to provide a first function of removing liquid from food, comprising:
(a) a first container;
(b) a base;
(c) an axle extending generally vertically from a bottom of said first container;
(d) a second container including a generally vertically extending funnel and engageable with at an upper end of said axle;
wherein said cooking appliance is configured to assume a first configuration in which said second container is rotably drivenable in relation to said first container for removing liquid from food contained in the second container, or a second configuration in which said second container is not rotably drivenable;
wherein said upper end of said axle includes a spring member formed into a structure with at least two fingers; and
wherein said spring member is biased to assume an expanded configuration which, allows said spring member to expand against an upper interior wall of said funnel and said second container to maintain position in the first configuration.

2. A cooking appliance as claimed in claim 1, wherein said first container has an oil capacity in the range from 0.5 L to 5.0 L.

3. A cooking appliance as claimed in claim 1, comprising a motor arranged at a lower end in said base, and is configured to rotate said second container to a speed from 100 rpm to 1000 rpm.

4. A cooking appliance as claimed in claim 1, wherein said second container is sized and shaped to contain food with a weight ranging from 100 g to 3 kg.

5. A cooking appliance as claimed in claim 1, wherein said second container is formed in a sieve-like structure for facilitating transfer of liquid from food contained therein to said first container.

6. A cooking appliance as claimed in claim 1, wherein said funnel is provided with a lower end having a tapered opening for receiving and aligning with said axle.

7. A cooking appliance as claimed in claim 1, wherein said funnel is provided with an indentation against which said male member or said fingers engage in the first configuration.

8. A cooking appliance as claimed in claim 1, wherein said upper end of said axle is provided with a male member having a pair of tongues sandwiching said fingers but without interfering with biasing movement of said fingers.

9. A cooking appliance as claimed in claim 1, wherein said at least two fingers are arranged adjacent to each other, of equal dimension and generally define a plane along which, in use, said spring member, expands in the first configuration, or compresses in the second configuration.

10. A cooking appliance as claimed in claim 1, wherein at least one of said fingers has a generally elongate profile.

11. A cooking appliance as claimed in claim 1, wherein said spring member is provided with opposite convex surfaces for engagement with said upper interior wall of said funnel.

12. A cooking appliance as claimed in claim 1, wherein said spring member is formed from a strip of elongate metallic material with a thickness ranging from 0.2 mm to 1 mm.

13. A cooking appliance as claimed in claim 1, wherein said male member includes at least three said fingers of generally equal dimension, and arranged on a plane defined by said three fingers.

14. A cooking appliance as claimed in claim 1, comprising a cover for closing said first container and a coupler attached to an underside of said cover, said coupler is positioned and dimensioned to restrict lateral movement of said axle.

15. A cooking appliance as claimed in claim 1, wherein said appliance is a combination fryer and food spinner configured to provide a second function of frying food.

16. A cooking appliance as claimed in claim 1, further comprising at least one stabilizer arranged at a lower end in said base, wherein total weight of said stabilizer(s) is up to 8 kg.

17. A cooking appliance as claimed in claim 1, having a weight of less than 10 kg.

18. A combination food fryer and food spinner, comprising:
(a) a first container;
(b) a second container receivable in said first container, said second container including a vertically extending funnel snap-fittable with a male member of an an axle extended from a bottom of said first container;
wherein said cooking appliance is configured to assume a first configuration in which said second container is rotably drivenable in relation to said first container for removing liquid from food contained in the second container or a second configuration in which said second container is positioned in a lower end in said first container in which food is fried; and
wherein said male member includes at least two fingers formed from at least one leaf spring and is biased towards a laterally expanded arrangement against an upper interior wall of said funnel, such that in the first configuration said second container is removably connected with said male member, allowing said cooking appliance to maintain position.

19. A cooking appliance as claimed in claim 18, wherein each or one of said fingers is in the form of a loop defined by said or part of said leaf spring.

20. A cooking appliance as claimed in claim 18, wherein said male member includes at least three fingers equally dimensioned, and arranged on a plane defined on said three fingers.
